(19) United States
(12) Patent Application Publication
(10) Pub. No.: US 2004/0133536 A1
(43) Pub. Date: Jul. 8, 2004

(54) Method and structure for template-based data retrieval for hypergraph entity-relation information structures

(75) Inventor: Rosario Uceda-Sosa, Hartsdale, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/326,375

(22) Filed: Dec. 23, 2002

(51) Int. Cl. G06F 7/00

(52) U.S. Cl. 707/1

(57) ABSTRACT

A method (and structure) to retrieve data from information structures based on an entity/relation paradigm and characterized as being a self-similar hypergraph, includes creating a template that matches a self-similar hypergraph format of the information structure. The template contains at least one query unit.

### CROSS-REFERENCE TO RELATED APPLICATIONS

The present Application is related to U.S. patent application Ser. No. ______, filed on ______, to Rosario Uceda-Sosa, entitled “METHOD AND STRUCTURE FOR UNSTRUCTURED DOMAIN-INDEPENDENT OBJECT-ORIENTED INFORMATION MIDDLEWARE”, having IBM Docket YOR920020216US1, and to U.S. patent application Ser. No. ______, filed on ______, to Rosario Uceda-Sosa, entitled “METHOD AND STRUCTURE FOR DOMAIN-INDEPENDENT MODULAR REASONING AND RELATION REPRESENTATION FOR ENTITY-RELATION BASED INFORMATION STRUCTURES”, having IBM Docket YOR920020217US1, both assigned to the present assignee, and both incorporated herein by reference.

### BACKGROUND OF THE INVENTION

1. Field of the Invention

The present invention generally relates to a template-based method to retrieve data from information structures based on the entity/relation paradigm and implemented as a hypergraph.

2. Description of the Related Art

Information systems where agents, human or artificial, interact with interconnected information resources are called “distributed knowledge environments”. They are the emerging information model of networks, ranging from digital library systems to the Internet and multi-agent cooperative environments. In the current model as further described herein, the information resources are mostly databases that function as passive file cabinets.

Agents must know the structure of the filing system in order to use it. That is, they must know which cabinet (table or view) contains the data they wish to access and must know or deduce why the data was stored there. For example, to access a database on real estate data, an agent must know that the table for “House” contains the city and price of houses, and that houses are located in cities, and have prices.

This example is trivial enough, but when data belongs to a specialized domain or when it needs to be discovered, as it often happens in distributed systems, agents do not know the details of the data organization in advance. Also, different agents view and organize data in different ways. For example, assuming and for purpose of discussion, human agents, such as a tax attorney, might view houses as taxable properties, while a prospective buyer is also interested in houses as habitation units with bedrooms, bathrooms, etc.

Building these open-ended information environments is a daunting task. For example, how can data be modeled when it is not known how it is going to be used? And, how can an agent access data whose organization is not known in advance? These questions are crucial to support intelligent agent systems where agents can evolve and share knowledge. A main challenge is to model and use information in a systematic, domain-independent manner, including the problem addressed by the present invention to provide a method to query such information structures.

### SUMMARY OF THE INVENTION

In view of the foregoing problems, drawbacks, and disadvantages of the conventional systems, it is a purpose of the present invention to provide a structure (and method) which allows sophisticated query capabilities for Entity-Relation information structures that are based on graphs and in which entire subgraphs can be easily queried with a simple clause language.

It is another purpose of the present invention to provide a structure and method for a lightweight implementation of a retrieval language on top of an entity-relation information structure that is based on graphs.

It is yet another purpose of the present invention to provide such a retrieval language that is easy and fast to implement and yet complete with respect to most usable subgraphs and allows entire subgraphs to be easily queried with a simple clause language.

In a first aspect of the present invention, to achieve the above and other purposes, described herein is method (and structure) to retrieve data from information structures based on an entity/relation paradigm and characterized as being a self-similar hypergraph, including creating a template that matches a self-similar hypergraph format of the information structure and that contains at least one query unit.

In a second aspect of the present invention, also described herein is a middleware module executing a template-based method to retrieve data from information structures based on an entity/relation paradigm and characterized as being a self-similar hypergraph, including a template constructor for creating a template that matches a self-similar hypergraph format of the information structure and that contains at least one query unit.

In a third aspect of the present invention, also described herein is a signal-bearing medium tangibly embodying a program of machine-readable instructions executable by a digital processing apparatus to perform the template-based method described above as executed by said middleware module.

In a fourth aspect of the present invention, also described herein is an apparatus executing the template-based method described above as executed by said middleware module.

In a fifth aspect of the present invention, also described herein is a network executing a template-based method described above as executed by said middleware module.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a sample node configuration 100 in according to the present invention;

FIG. 2 illustrates a sample template 200 with exemplary constraints;

FIG. 3 is an exemplary process 300 of using a template in accordance with the present invention;

FIG. 4 provides an exemplary template 400 for demonstrating a template evaluation process of the present invention;

FIG. 5 is an exemplary IRIS (Information Representation Inferencing Sharing) architecture 500;

FIG. 6 illustrates an exemplary IRIS GUI (Graphic User Interface) 600;

FIG. 7 illustrates an exemplary hardware/information handling system 700 for incorporating the present invention therein; and

FIG. 8 illustrates a signal bearing medium 800 (e.g., storage medium) for storing steps of a program of a method according to the present invention.

### DETAILED DESCRIPTION OF A PREFERRED EMBODIMENT OF THE INVENTION

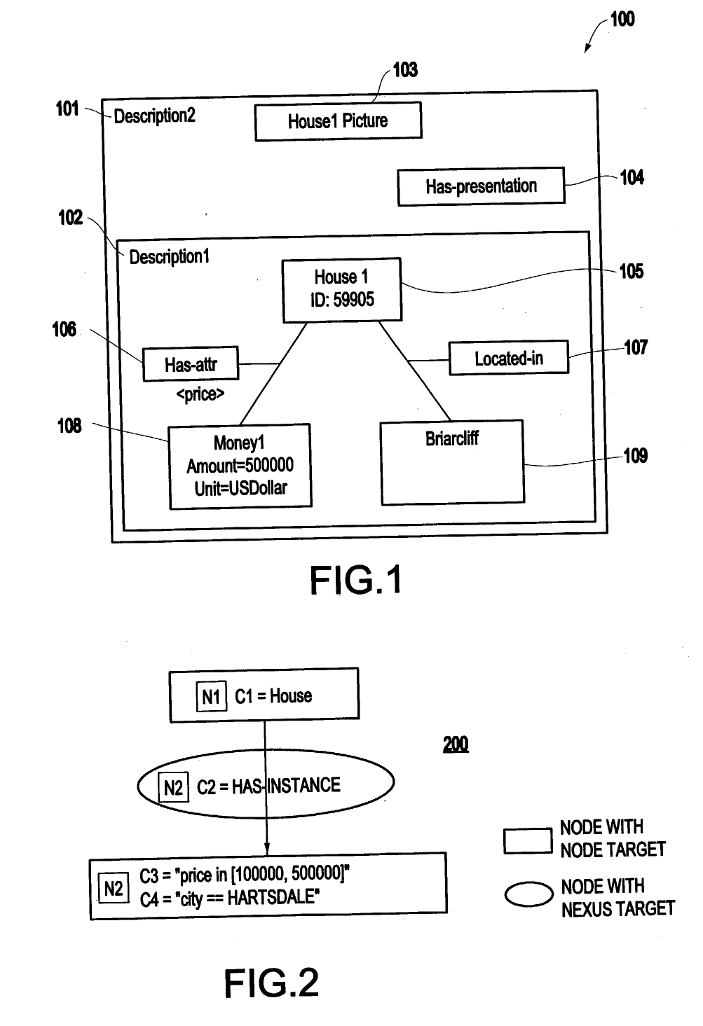

Referring now to the drawings, and more particularly to FIG. 1, a preferred embodiment will now be described. The present invention provides a lightweight implementation of a retrieval language on top of an entity-relation structure such as shown in FIG. 1.

The technique described herein has been implemented as one aspect of a middleware module called IRIS (Information Representation Inferencing Sharing), further described in the above-listed copending applications. IRIS is additionally described in an article entitled “IRIS: An Intelligent Information Infrastructure For Distributed Knowledge Environments”, published in the 2002 Proceedings of the International Conference on Intelligent Information Technology, pages 113-119, ISBN 7-115-75100-5/0267. The contents of this article are also incorporated by reference.

FIG. 1 shows a sample node configuration 100 as might be used for IRIS as implemented to be middleware for a real estate database. Every rectangle 101-109 is an IRIS node, including Description1 101 and Description2 102, which are nodes describing subgraphs.

The present invention addresses a template-based method, as exemplarily implemented in IRIS, to retrieve data from information structures based on the entity-relation paradigm and implemented as a hypergraph (as is done in IRIS). In the entity-relation paradigm, data is encapsulated in entities with relations among them. Usually these structures are implemented as graphs, where nodes are entities and arcs have relations as labels. It is assumed that n-ary arcs are allowed in the underlying information structure.

The method of the present invention will work in any such environment, but for illustration purposes, the IRIS representation and its reasoning will be used, as described in the above-referenced co-pending applications.

A number of features of the information structure of the IRIS middleware described in greater detail in the first above-listed copending application distinguishes it from conventional information structures. One distinguishing feature is that it is based on the entity/relation paradigm and is implemented as a self-similar hypergraph. What this means is that an IRIS space (e.g., the unit of information in IRIS) can be a node that includes an entire network of nodes. A second distinguishing feature is that relations can be nodes, so that relations can be related to other nodes or relations.

Templates

Referring to FIG. 2, a template 200 is a subgraph, made up of the same nodes and links as the underlying information structure, as, for example, IRIS. Each node in the template subgraph has a predefined target, either a node or a relation. In IRIS terminology, the target is either an INode or an INexus. Template nodes that target nodes are connected by links. Links are labeled by nodes with target relations. There is a distinguished template node called the “anchor” of the template, used to start the evaluation of the graph.

Each node contains a set of clauses, which are expressions to be satisfied by instances in the underlying information structure. Preferably, there are two types of clauses, depending on the target of the host node:

1. Nexus Clause: It is either NULL or a string that names a relation. A nexus clause list is OR'ed.

2. Node Clause: It is either NULL or a string that contains an expression. A node clause list is AND'ed. A node clause may be illustrated by the following example using BNF (Backus Naur Form) grammar:

```
NODE_CLAUSE ::= NULL | PREDICATE | “NOT” PREDICATE
PREDICATE ::= LHS | LHS RELOP VALUE_RANGE_ELEMENT |
                LHS IN [VALUE_RANGE]
LHS ::= NULL | NAME
VALUE_RANGE ::= VALUE_RANGE_ELEMENT,
VALUE_RANGE |
            VALUE_RANGE_ELEMENT
VALUE_RANGE_ELEMENT ::= VALUE | VALUE .. VALUE
RELOP ::= “<” | “<=” | “>” | “>=” | “==” | “!=”
```

Template 200 illustrates a simple template with sidus nodes N1 (the anchor) and N2. The Nexus target is N2. The sidus constraints are C1, C3 and C4. The nexus constraint is C2. Template 200 asks for instances of Houses with prices between $100,000 and $500,000 in the city of Hartsdale.

Template Construction and Population API (Application Program Interface)

In what follows, SNode is a template node with target node, while NNode is a template node with target nexus. In a preferred embodiment of the invention, the following functions (methods) to build a template are needed:

A. SNode(NodeClauseList clauseList)—Constructor for a node with target node, from a node clause list.

B. NNode(NexusClauseList clauseList)—Constructor for a node with target Nexus, from a nexus clause list.

C. Template(SNode anchor)—Constructor for the template with a given anchor. It must be an SNode.

D. Link Template.addLink(SNode from, SNode to, NNode label)—adds a link between SNodes labeled with a Nnode.

Thus, in FIG. 2, N1 and N3 are the SNodes and N2 is the NNode.

Taking the sample template “(House, price in [100000, 500000], city==HARTSDALE)” shown in FIG. 2 as an example, the template 200 would be set up by either entering the following pseudocode or having a software module provide cues to assist in setting up the template:

```
  SList.add(“House”);
  Sanchor = new SNode(SList);
  HouseTemplate = Template(SAnchor);
  Clist.add(“price in [100000, 500000]);
  Clist.add(“city == HARTSDALE”);
  Cnode = newSNode(Clist);
  HouseTemplate.addLink(SAnchor, HAS-INSTANCE, Cnode);
  LinkTemplate.addLink(House, price in [100000, 500000], city ==
HARTSDALE).
```

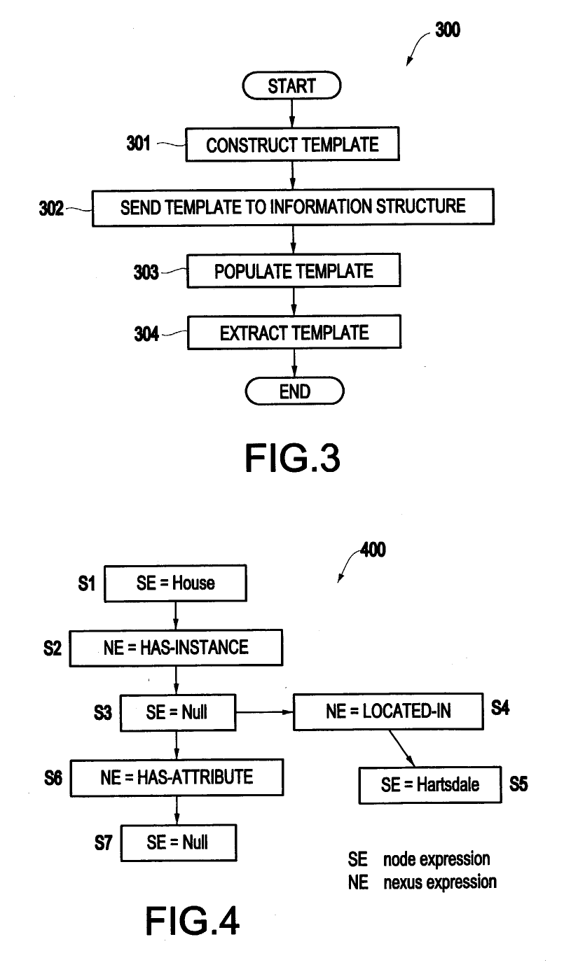

As shown in the process 300 of FIG. 3, after building the template in step 301 using a technique similar to that described above, in step 302 the template is then sent to the underlying information structure to be filled up with data.

Each node is associated with satisfying instances, starting with the anchor. This process, shown as step 303 in FIG. 3, is called “population”, and a template is said to be populated after such process.

Finally, in step 304, data is placed in object format in a process called “extraction”. Typically, the extracted data would additionally be displayed and/or stored in a data file, and a graphic user interface would be implemented for a user interface to define a template and view the result of the query.

The following functions (methods) are exemplarily used to retrieve data from the underlying information structure. IRIS terminology is used for illustration purposes:

Template.populate(Graph graph)—populates the data from the graph (in IRIS terminology, from the IRIS space). An exemplary population algorithm is given below.

LIST Template.extract(BOOLEANprefix)—returns data as a list of objects obtained by ‘collapsing’ instances in the template. The result is a collection of objects that contains the slots of the network. A slot is a pair <name, value> where the value is the information stored in the network.

Before presenting exemplary algorithms for the populate and extract functions, FIG. 4 provides a more qualitative discussion for the process. In FIG. 4, template 400 requests information on houses (S1) available in the city of Hartsdale (S5). Each node is labeled S1 and contains either a node expression (SE) or a nexus expression (NE).

The anchor node for template 400 is S1, which is used to identify data nodes by name, thereby starting the template evaluation. After evaluating the anchor, paths ending with a node expression are traversed in breadth-first fashion to find satisfying data in the target space. Each path is inferred, so that data may be gathered anywhere in the space.

Thus, according to the example of FIG. 4, the evaluation of the template 400 matches S1 against the concept House. Then, instances of House are added to S2 and S3, which are evaluated together since S3 is a target node. Next, S4 and S5 are evaluated, and filled with satisfying branches from the content of S3. The same is done with S6 and S7.

It is noted that, if S6-S7 were evaluated before S4-S5, all attributes of all instances of House would be gathered unnecessarily, when only those in Hartsdale are being sought in the query. Thus, by comparing child clause paths and ordering them by specificity of their clauses, unnecessary gathering is avoided. In the example, S4-S5 is evaluated first, since S7 has a null clause and, therefore, is less specific.

Once evaluated, the template is traversed backwards, pruning unsatisfied subspaces. After the evaluation process, the anchor contains a collection of subspaces matching the structure of the template. Agents obtain the result data from the anchor content. Each resulting subspace can also be collapsed into a single object with fields. For example, in this template 400 evaluation, a collection of Houses instances is returned.

Based on this overview of an exemplary population and extraction process, the following more detailed description provides the basis for one possible implementation in software.

Exemplary Template Population Algorithm

Each template SNode preferably has two lists: SourceNodeSatisfied and SourceNodeUnsatisfied. Each NNode has a SourceSatisfiedLink list. Each node (SNode and NNode) has an integer counter Visited, which is initialized to 0. Templates are exemplarily populated in the following steps:

I. Identify the satisfying nodes for the anchor. This is done by applying the node clauses in the anchor. Each template node satisfying the clauses is associated (through references) to the anchor SNode. These nodes are called “source nodes”, and are placed in the SourceNodeSatisfied list. Increment Visited.

II. From the SNode visited most recently, call it VN, look at each link and SNode at its end, call it TN. The NNode that labels the link is called NN.

If NNode.Visited>0, return. Otherwise, for each source node in VN, select all outgoing links labeled with any of the relations in NN.

Apply the clause lists in TN. If they are all satisfied, add the node to the SourceNodeSatisfied list of TN. If not, add the node to the list SourceNodeUnsatisfied list of TN. Add the link to the list of NN. Increment Visited of NN and TN. Repeat this step until no new links can be visited. In order to improve performance, it is important to order all the NNodes according to the specificity of their constraints whenever applicable. Paths leading to more specific constraints are traversed first.

III. Start at the anchor, and visit in the same order as II, all nodes. If a node has a SourceNodeUnsatisfied nonempty list, traverse the node back, eliminating each node in the SourceNodeSatisfiedList that has no links to any other satisfied source nodes in the neighbors of the current SNode.

All the source nodes that are related by links in the NNodes of a template are called source node graphs.

Exemplary Template Extraction Algorithm

Template extraction provides a list of objects that contain all slots of the source node graphs in the populated template. First, all the Visited counters are re-initialized to 0.

I. Create an empty list (e.g., called ResultList).

II. Start at the anchor. For each member of the SourceNodeSatisfied, create a new node and add all the slots of the source node to the new node in ResultList. Increment Visited

III. From the SNode visited most recently, call it VN, look at each link and SNode at its end, call it TN. The NNode that labels the link is called NN. If NNode.Visited>0, return. Otherwise, for each source node in VN, select all outgoing links associated to NN. Locate their corresponding ends in TN. Call one of these nodes TSourceNode. For each of its slots, if prefix is TRUE, add the name of the path from the anchor to the name of the slot in TSourceNode to the corresponding node in ResultList.Increment Visited of NN and TN. Repeat this step until no new links can be visited.

IV. Return ResultList.

IRIS Architecture

IRIS was developed as the information infrastructure of an intelligent user interface, RIA (Responsive Information Architect) that interprets the end user's request for information and crafts a multimedia presentation (graphics and speech) on the fly. Each of the modules of RIA (graphics designer, speech designer, conversation manager) works as an agent that requires domain and presentation information from different perspectives. IRIS offers a unified information repository that at the same time is dynamically tailored to the modules' needs.

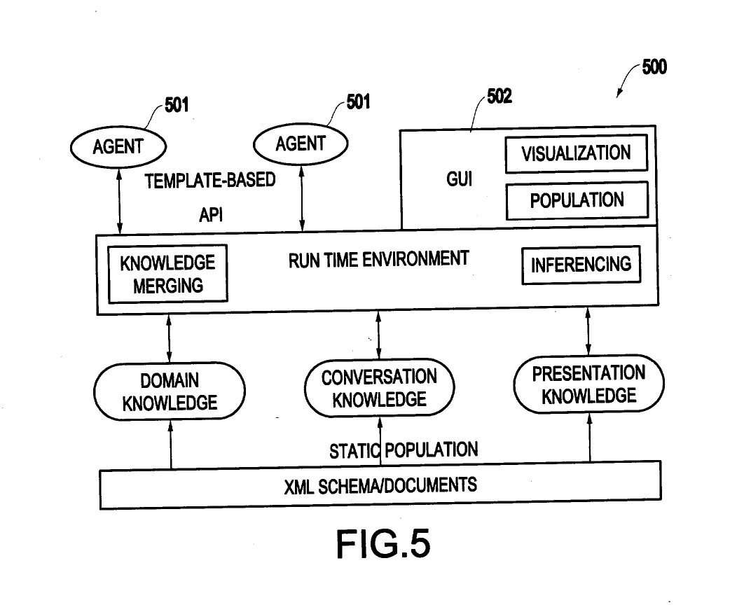

The architecture 500 of the prototype of IRIS is depicted in FIG. 5. The features of IRIS have been selected to satisfy the needs of several, possibly independent, agents 501 accessing distributed information sources. In the realm of the RIA, IRIS represents domain, media and upper ontologies and data, as well as the conversational structure of the interface, in sizable spaces (50,000 nodes, 75,000 nexus). A GUI 502 is also provided for the population and visualization of spaces, as well to issue simple template-based queries.

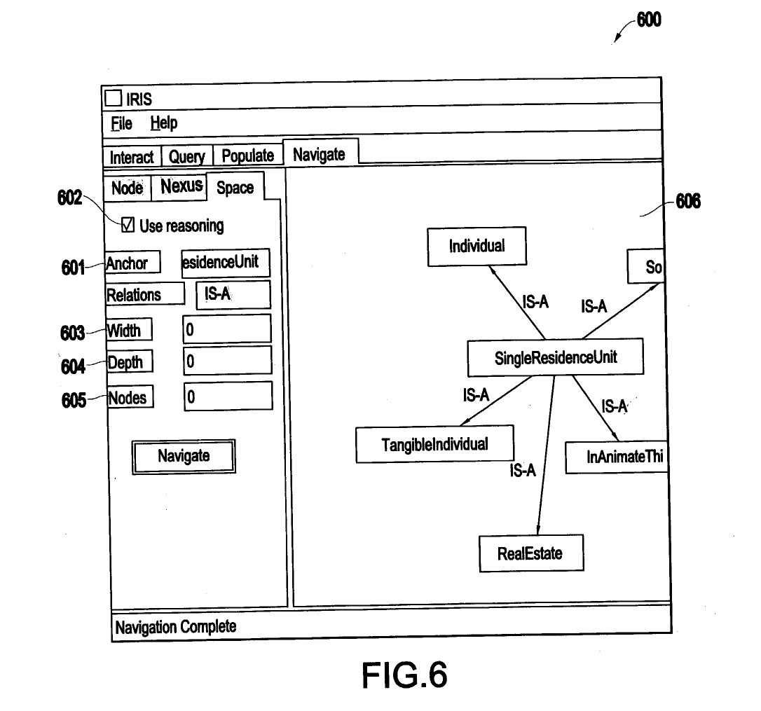

FIG. 6 illustrates a fragment 600 of a screen capture of the working interface with the prototype real estate and upper ontology. The GUI provides population and visualization tools, as well as a simple template-based query facility.

In FIG. 6, an exemplary space subpane is used to issue simple template-based queries. In the example, the anchor 601 is SingleResidenceUnit, and the Use reasoning tag 602 indicates that the relations shown are obtained through inferencing, regardless of what the underlying relations on the IRIS space are. The Width 603, Depth 604, and Nodes 605 restrict the shape of the result. In particular, Nodes 605 indicates the maximum number of descendants of the anchor to be obtained. The entire pane 606 defines a simple template, as discussed briefly above.

As mentioned above, IRIS has been implemented as a library of information services in Java, and is fully operational. IRIS was designed to serve as an information infra-structure to a multimedia intelligent interface, where the modules of the architecture work as independent agents that access several repositories and require specific data content and organization. Since the present invention defines the range of information services, these agents are enabled to access integrated, yet customized information.

Even though the IRIS middleware has been described herein using Java-like conventions, it is generic enough to be implemented in any Object-Oriented environment, as one of ordinary skill in the art would recognize. This infrastructure does not depend on any specific data semantics or data organization, and it can flexibly represent not only declarative data like concepts and instances, but also relations, contexts, and even constraints and methods. Hence, it can be applied to virtually any knowledge domain and any information paradigm, from relational databases to semantic networks.

Other examples where IRIS middleware has been applied to date include automated auto diagnosis, authoring of business rules for e-commerce, and autonomic computing.

Exemplary Hardware Implementation

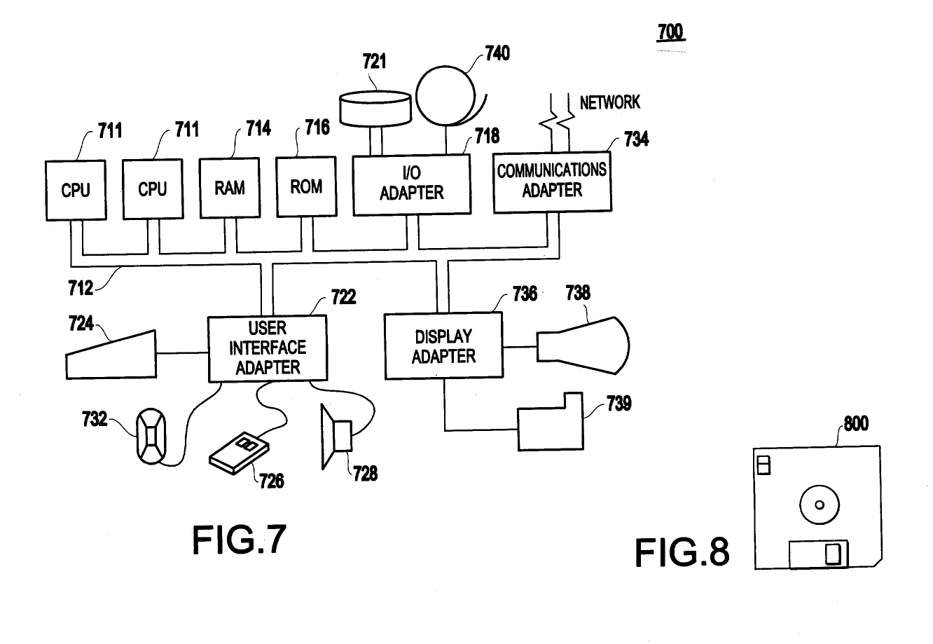

FIG. 7 illustrates a typical hardware configuration of an information handling/computer system in accordance with the invention and which preferably has at least one processor or central processing unit (CPU) 711.

The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, an Intranet, a personal area network (PAN), etc., and a display adapter 736 for connecting the bus 712 to a display device 738 and/or printer 739 (e.g., a digital printer or the like).

Those skilled in the art will recognize that the exemplary environment illustrated in FIG. 7 is not intended to limit the present invention. Those skilled in the art will appreciate that other alternative systems may be used without departing from the spirit and scope of the invention.

An alternative aspect of the invention includes a computer-implemented method for performing the above method. As an example, this method may be implemented in the environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a program product, comprising signal-bearing media tangibly embodying a program of machine-readable instructions executable by a digital data processor incorporating the CPU 711 and hardware above, to perform the method of the invention.

This signal-bearing media may include, for example, a RAM contained within the CPU 711, as represented by the fast-access storage for example. Alternatively, the instructions may be contained in another signal-bearing media, such as a magnetic data storage diskette 800 (FIG. 8), directly or indirectly accessible by the CPU 711.

Whether contained in the diskette 800, the computer/CPU 711, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

It should also be obvious to one of ordinary skill in the art that the technique of the present invention may be implemented on a network in a variety of configurations. For example, a user at a first computer having an API module could be remote from a second computer which has data stored in memory having the representation model of IRIS, allowing the remote user to query the pre-existing data in the second computer. The pre-existing data in the second computer could be searched by either downloading the data to the first computer and conducting the search in the first computer or by having a second middleware module installed in the second computer to conduct the search in the second computer and return the results to the first computer.

In another configuration, the middleware module could be separable so that a first computer user has access to only the template constructor portion, thereby allowing that user to enter a template locally, which template is then transmitted to a second computer for evaluation by the second computer of a data base stored on that second computer.

The network could also be used to allow the transfer of the middleware module to download for remote users to then implement the API query. The middleware module might be transferred as an entire module or might be only partially transferred so that the remote user could only construct a template and must then transmit the template for evaluation by another computer.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what I claim as new and desire to secure by Letters Patent is as follows:

1. A method to retrieve data from information structures, said method comprising:
generating a template containing at least one query unit,
wherein both of an information structure being queried by said template and said template are based on an entity/relation paradigm and are characterized as having a self-similar hypergraph (“fractal”) format, said self-similar hypergraph format representing a graph in said information structure which comprises one or more nodes and each said node selectively comprises an entire subgraph.

2. The method of claim 1, further comprising:
comparing said template against an information unit in said information structure to determine whether said information unit matches said at least one query unit.

3. The method of claim 2, further comprising:
returning data of said information structure matching said at least one query unit.

4. The method of claim 3, wherein said information structure comprises a plurality of information units, each said information unit comprises at least one node and at least one relation in a hypergraph structure, said template comprises a subgraph, and each node in said template subgraph comprises at least one predefined target, said at least one predefined target comprising at least one of a target node and a target relation, and said template subgraph further comprises an anchor node used to start an evaluation of said comparing.

5. The method of claim 4, wherein said comparing comprises, for each said information unit in said information structure:
initially comparing said template anchor node with a node in said information unit; and
if said template anchor node matches a node in said information unit, systematically comparing each element of said template subgraph against any of a corresponding element of said information unit.

6. The method of claim 5, wherein said returning data comprises:
returning all of said at least one predefined target extracted from each said information unit that matches said template subgraph.

7. A middleware module executing a template-based method to retrieve data from information structures, said middleware module comprising:
a template constructor for creating a template that matches a self-similar hypergraph format of said information structure, said template containing at least one query unit, wherein said information structure is based on an entity/relation paradigm and is characterized as having a self-similar hypergraph (“fractal”) format, said self-similar hypergraph format representing a graph in said information structure which comprises one or more nodes and each said node selectively comprises an entire subgraph.

8. The middleware module of claim 7, further comprising:
a comparator to compare said template against an information unit in said information structure to determine whether said information unit matches said at least one query unit; and
a data transfer unit to return data in said information structure matching said at least one query unit.

9. The middleware module of claim 8, wherein said information structure comprises a plurality of said information units, each said information unit comprises at least one node and at least one relation in a hypergraph structure, said template comprises a subgraph, and each node in said template subgraph comprises at least one predefined target, said at least one predefined target comprising at least one of a target node and a target relation, and said template subgraph further comprises an anchor node used to start an evaluation.

10. The middleware module of claim 9, wherein said comparator comprises:
a population module including an initial comparison module that initially compares said template anchor node with a node in one of said information unit under evaluation.

11. The middleware module of claim 10, said population module further comprising a subsequent comparison module that, if said template anchor node matches a node in said information unit, systematically compares each element of said template subgraph against any of a corresponding element of said information unit under evaluation.

12. The middleware module of claim 8, wherein said data transfer unit includes:
an extraction module that returns said at least one predefined target extracted from each said information unit that matches said template subgraph.

13. A signal-bearing medium tangibly embodying a program of machine-readable instructions executable by a digital processing apparatus to perform a template-based method to retrieve data from information structures, said method comprising:
creating a template containing at least one query unit, wherein an information structure being queried by said template and said template are each based on an entity/relation paradigm and are each characterized as having a self-similar hypergraph (“fractal”) format, said self-similar hypergraph format representing a graph in said information structure or template which comprises one or more nodes and each said node selectively comprises an entire subgraph.

14. The signal-bearing medium of claim 13, said method further comprising:
comparing said template against an information unit in said information structure to determine whether said information unit matches said at least one query unit.

15. The signal-bearing medium of claim 14, said method farther comprising:
returning data in said information structure matching said at least one query unit.

16. An apparatus executing a template-based method to retrieve data from information structures, said apparatus comprising:
a template constructor for creating a template that matches a self-similar hypergraph format of an information structure, said template containing at least one query unit, wherein said information structure is based on an entity/relation paradigm and is characterized as having a self-similar hypergraph (“fractal”) format, said self-similar hypergraph format representing a graph in said information structure which comprises one or more nodes and each said node selectively comprises an entire subgraph.

17. The apparatus of claim 16, further comprising:
a comparator to compare said template against an information unit in said information structure to determine whether said information unit matches said at least one query unit; and
a data transfer unit to return data in said information unit matching said at least one query unit.

18. The apparatus of claim 17, wherein said information structure comprises a plurality of said information units, each said information unit comprises at least one node and at least one relation in a hypergraph structure, said template comprises a subgraph, and each node in said template subgraph comprises at least one predefined target, said at least one predefined target comprising at least one of a target node and a target relation, and said template subgraph further comprises an anchor node used to start an evaluation.

19. A network executing a template-based method to retrieve data from information structures, said network comprising:
a first computer having a middleware module executing a template-based method to retrieve data from information structures based on an entity/relation paradigm and characterized as being a self-similar hypergraph, said middleware module comprising:
a template constructor for creating a template that matches a self-similar hypergraph format of said information structure, said template containing at least one query unit, wherein said information structure is based on an entity/relation paradigm and is characterized as having a self-similar hypergraph (“fractal”) format, said self-similar hypergraph format representing a graph in said information structure which comprises one or more nodes and each said node selectively comprises an entire subgraph.

20. The network of claim 19, wherein said middleware module in said first computer further comprises:
a comparator to compare said template against an information unit in said information structure to determine whether said information unit matches said at least one query unit; and
a data transfer unit to return data in said information structure matching said at least one query unit.

21. The network of claim 19, further comprising:
a second computer having stored therein an information structure corresponding to a self-similar hypergraph format matching said template.

22. The network of claim 21, wherein said second computer includes a middleware module comprising:
a comparator to compare a template received from said first computer against an information unit in said information structure to determine whether said information unit matches said at least one query unit; and
a data transfer unit to return data in said information unit matching said at least one query unit, thereby allowing a comparator and a data transfer unit in said middleware module of said second computer to process a query in said received template.

23. A node in a computer system, said node comprising:
a receiver for receiving data retrieved from a query of an information structure, said retrieved data being data that matches a template query, said information structure being based on an entity/relation paradigm and characterized as having a self-similar hypergraph (“fractal”) format, said self-similar hypergraph format representing a graph in said information structure which comprises one or more data-unit-nodes, wherein each said data-unit-node selectively comprises an entire subgraph, said matched data resulting from a comparison of a template that matches a self-similar hypergraph format of said information structure, and said template containing at least one query unit.

24. A node in a computer system, said node comprising:
a generator for generating a query template for an information structure having a self-similar hypergraph (“fractal”) format, said template containing at least one query unit, said self-similar hypergraph format representing a graph in said information structure which comprises one or more data-unit-nodes, wherein each said data-unit-node selectively comprises an entire subgraph.
